(19) United States
(12) Patent Application Publication
(10) Pub. No.: US 2014/0044911 A1
(43) Pub. Date: Feb. 13, 2014

(54) SYSTEM FOR ATTACHING AN EXTERNAL OBJECT TO A CLOTH

(71) Applicant: Hao Shi, Redondo Beach, CA (US)

(72) Inventor: Hao Shi, Redondo Beach, CA (US)

(21) Appl. No.: 13/571,746

(22) Filed: Aug. 10, 2012

(51) Int. Cl. B32B 7/12; B32B 37/00

(52) U.S. Cl. 428/41.8; 156/60; 428/354

(57) ABSTRACT

One example embodiment includes a system for attaching an external object to a cloth. The system includes a base layer. The system also includes a first adhesive layer, where the first adhesive layer is applied to a first side of the base layer. The system further includes a second adhesive layer, where the second adhesive layer is applied to a second side of the base layer, where the second side of the base layer is opposite the first side.

### CROSS-REFERENCE TO RELATED APPLICATIONS

This application is related to co-pending U.S. application Ser. No. ______, filed on ______, 2012, and entitled, “PROTECTOR FOR PROTECTING AND ATTACHING AN EXTERNAL OBJECT TO A CLOTH” (Attorney Docket No. 10371.6), which application is incorporated herein by reference in its entirety.

This application is related to co-pending U.S. application Ser. No. ______, filed on ______, 2012, and entitled, “BADGE FOR ATTACHING AN EXTERNAL OBJECT TO A CLOTH” (Attorney Docket No. 10371.7), which application is incorporated herein by reference in its entirety.

### BACKGROUND OF THE INVENTION

Many people use clothing to send a message about themselves. I.e., their selection of clothing is often a reflection of the wearer or of a statement that the wearer intends to make. For example, clothing can include a political or cultural statement. Clothing can reflect a wearer's values or include brand names that the wearer either likes or supports.

However, clothing tends to often be mass produced with the result that many people own the same article. Because of this the wearer may wish to personalize his/her clothing. I.e., the wearer may wish to add certain decorations to his/her clothing. The decorations can include any 3D or 2D object which is added to the clothing. For example, the decorations the wearer desires to add can include a picture or other print.

However, customizing clothing can be an expensive and time consuming process. In particular, printing or adding designs to clothing can require expensive machinery. Often, the cost of such customization requires scale in order to become cost efficient. Therefore, some services which can customize clothing require minimum orders. I.e., an order must include a minimum number of clothing pieces to be customized or the order will be refused.

In addition, the more customization to be done, the more expensive the process. That is, a small amount of text or design costs less than a larger amount of text or design. Therefore, the customization may be limited to a small amount of design. I.e., the cost limitation to a high degree of customization may be difficult to overcome, especially for an individual or small order.

Further, this customization is permanent. I.e., the customization is printed directly onto the clothing and is difficult to remove without damaging the clothing. This means that once the decision has been made to add a certain customization, the decision may be permanent with respect to a particular garment.

Accordingly, there is a need in the art for a system which can allow a user to easily customize clothing. In addition, there is a need in the art for the system to be changeable. Further, there is a need in the art for the customization to allow the addition of larger designs.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a system for attaching an external object to a cloth. The system includes a base layer. The system also includes a first adhesive layer, where the first adhesive layer is applied to a first side of the base layer. The system further includes a second adhesive layer, where the second adhesive layer is applied to a second side of the base layer, where the second side of the base layer is opposite the first side.

Another example embodiment includes a system for attaching an external object to a cloth. The system includes a base layer. The system also includes a first adhesive layer, where the first adhesive layer is applied to a first side of the base layer. The system further includes a second adhesive layer, where the second adhesive layer is applied to a second side of the base layer, where the second side of the base layer is opposite the first side. The system additionally includes a second base layer. The system also includes a third adhesive layer, where the third adhesive layer is applied to a first side of the second base layer. The system further includes a fourth adhesive layer, where the fourth adhesive layer is applied to a second side of the second base layer, where the second side of the second base layer is opposite the first side of the second base layer. The system additionally includes a backing, where the backing separates the second adhesive layer from the third adhesive layer and releasably attaches the second adhesive layer to the third adhesive layer.

Another example embodiment includes a method for manufacturing a system for attaching an external object to a cloth. The method includes providing a base layer. The method also includes applying a first adhesive layer, where the first adhesive layer is applied to a first side of the base layer. The method further includes applying a second adhesive layer, where the second adhesive layer is applied to a second side of the base layer, where the second side of the base layer is opposite the first side.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example of a system for customizing a cloth;

FIG. 2 illustrates an example of the system attached to an external object;

FIG. 3 illustrates an example of the system attaching an external object to a cloth; and

FIG. 4 is a flow chart illustrating a method of manufacturing a system for customizing a cloth; and

FIG. 5 illustrates an example of a clip for attaching a decoration to a cloth.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

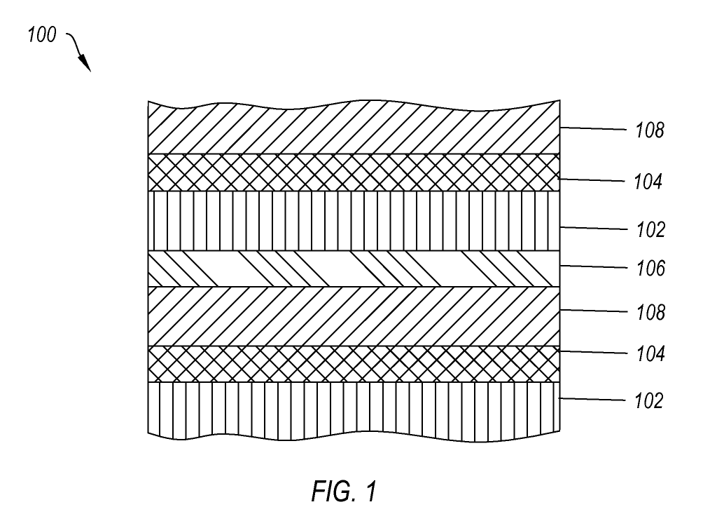

FIG. 1 illustrates an example of a system 100 for customizing a cloth. In at least one implementation, the cloth can include clothing, other cloth and cloth-like materials. I.e., the system 100 can allow a user to customize the look of his/her clothing. Additionally or alternatively, the system 100 can allow the user to customize upholstery or other furniture coverings. One of skill in the art will appreciate that any cloth can be customized and that clothing and cloth and examples and not limiting herein unless otherwise specified in the claims.

FIG. 1 shows that the system 100 can include a base layer 102. In at least one implementation, the base layer 102 can include any desired material. For example, the base layer 102 can include paper, plastic film, cloth, metal foil or any other desired material. The base layer 102 can be any desired size and shape in order to accommodate the external object. For example, the user may be able to cut or otherwise reshape the base layer 102. The base layer 102 can include coloring or decorations or can be transparent or semi-transparent.

FIG. 1 also shows that the system 100 can include a first adhesive layer 104. In at least one implementation, the first adhesive layer 104 is configured to attach the system 100 to a cloth. I.e., the first adhesive layer 104 can attach the base layer 102, and any external objects attached thereto, to the cloth. The first adhesive layer 104 can include a pressure sensitive adhesive. Pressure sensitive adhesive (PSA, self-adhesive, self-stick adhesive) is adhesive which forms a bond when pressure is applied to marry the adhesive with the adherend. I.e., no solvent, water, or heat is needed to activate the adhesive

FIG. 1 further shows that the system 100 can include a second adhesive layer 106. In at least one implementation, the second adhesive layer 106 is configured to attach the base layer 102 to an external object. In particular, the second adhesive layer 106 can secure the external object to the base layer 102 while the first adhesive layer 104 is secured to the cloth, with the end result being that the external object is secured to the cloth. The second adhesive layer 106 can include the same adhesive or a different adhesive, as desired.

FIG. 1 additionally shows that the system 100 can include a backing 108. In at least one implementation, the backing 108 can protect the adhesive until the desired time of use. I.e., the backing 108 can include a material which attaches to either the first adhesive layer 104 or the second adhesive layer 106, or both, but does not remove the adhesive layer. The backing 108 can include any desired material. For example, the backing 108 can include a waxed paper. Additionally or alternatively, the backing 108 can protect the first adhesive layer 104 or the second adhesive layer 106 before use.

FIG. 1 also shows that the system 100 can include multiple sections of base layer 102, surrounded by the first adhesive layer 104 and the second adhesive layer 106 separated by a backing 108. I.e., the backing 108 can protect a first adhesive layer 104 of a first base layer 102 on one side and a second adhesive layer 106 attached to a second base layer 102 on the opposite side. Additionally or alternatively, the backing 108 can attach the multiple sections of base layer 102 to one another. I.e., the backing 108 can allow two base layers 102 to attach to one another. One of skill in the art will appreciate that more than two base layers 102 can be used. In particular, any desired number of base layers 102 can be added to the system, as desired.

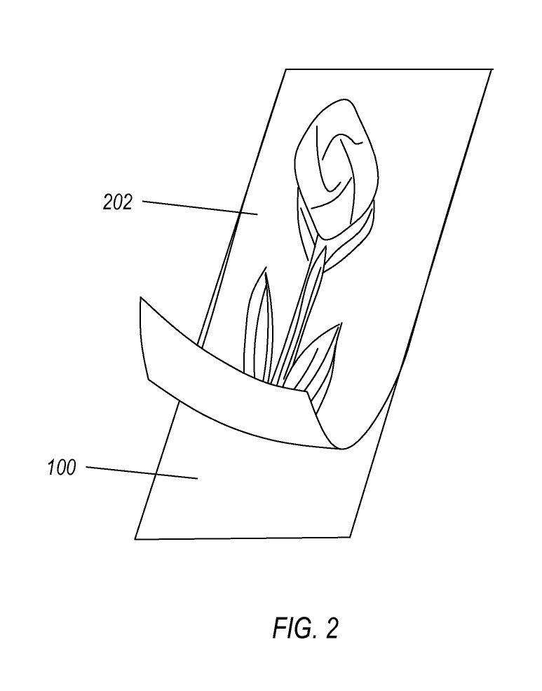

FIG. 2 illustrates an example of the system 100 attached to an external object. In at least one implementation, the system 100 is configured to secure the external object to a cloth. For example, the system 100 can be attached to a wearer's clothing.

FIG. 2 shows that the second adhesive layer 106 can attach to an external object 202. In at least one implementation, the external object 202 can be any desired object. For example, the external object 202 can be a photograph or other picture. Additionally or alternatively, the external object can be a three dimensional object. For example, the external object 202 can include a decorative item.

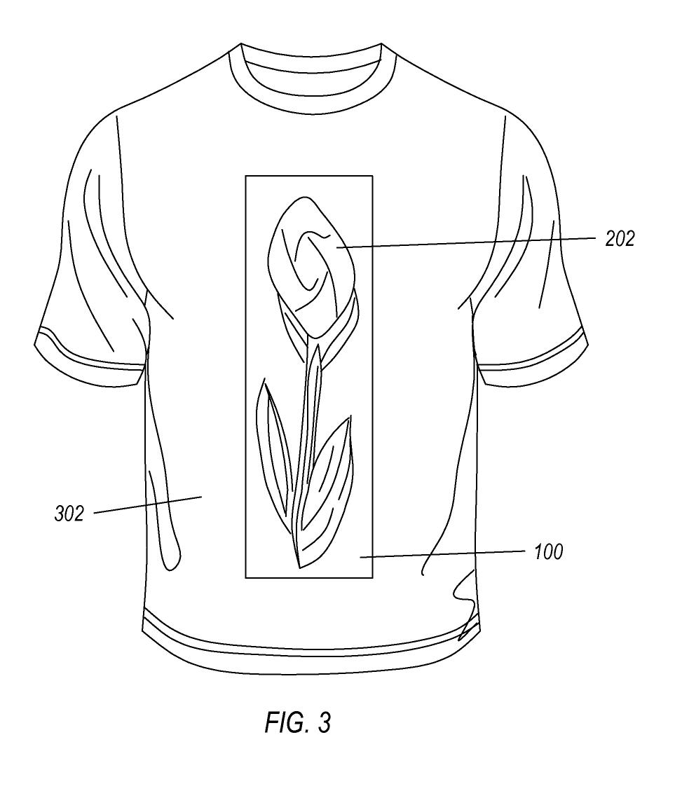

FIG. 3 illustrates an example of the system 100 attaching an external object 202 to a cloth. In at least one implementation, the external object 202 can be releasably attached by removing the backing protecting the first adhesive layer 104 and/or the second adhesive layer 106 and by removing a single base layer 102. I.e., the external object 202 can be attached and removed as desired by the wearer. Additionally or alternatively, different external objects 202 can be attached to the cloth, as desired.

FIG. 3 shows that the first adhesive layer 104 can attach to a cloth 302. In at least one implementation, the cloth 302 can include any desired material. For example, the cloth 302 can include leather, artificial leather, suede, vinyl, a fabric or any other desired material. The cloth 302 can be used for any desired purpose. For example, the cloth 302 can include clothing, bedding, hats, totes, upholstery covers or any other desired covering or material. For example, the system 100 can be used on mattress and boxspring encasement covers and other uses that may require this type of fastening security.

Leather is a durable and flexible material created via the tanning of putrescible animal rawhide and skin, primarily cattlehide. Artificial leather includes any fabric or finish intended to substitute for leather where a leather-like finish is desired but the actual material is cost-prohibitive or unsuitable. Suede includes kid or other leather finished with a soft, napped surface, on the flesh side or on the outer side after removal of a thin outer layer. Vinyl includes any resin formed by polymerization of vinyl compounds or plastics made from such resins. A vinyl compound is any organic compound that contains a vinyl group (Preferred IUPAC name ethenyl). Vinyl groups (formula —CH═CH2) are derivatives of ethene, CH2=CH2, with one hydrogen atom replaced with some other group.

Fabrics include any network of natural or artificial fibers including textiles. In at least one implementation, the fibers can include thread or yarn. For example, yarn can be produced by spinning raw wool fibers, linen, cotton, or other material on a spinning wheel to produce long strands. Fabrics can be formed by weaving, knitting, crocheting, knotting, or pressing fibers together, such as in felt. One of skill in the art will appreciate that a fabric can include a single fiber or more than one fiber.

In at least one implementation, fibers, also spelled fibres, is a class of materials that are continuous filaments or are in discrete elongated pieces. In particular, fibers can be spun into filaments, string or rope, used as a component of composite materials, or matted into sheets to make products such as paper or felt. Additionally or alternatively, fibers can include yarn, thread, string, filaments, twine, cord, or any other material that can be used to form a fabric or cloth. In particular, yarn is a long continuous length of interlocked fibers, suitable for use in the production of textiles, sewing, crocheting, knitting, weaving, embroidery and rope making. Additionally or alternatively, thread is a type of yarn intended for sewing by hand or machine. Yarn and/or thread may be finished with wax or other lubricants to withstand the stresses involved in sewing or otherwise manufacturing the fabric.

Natural fibers can include animal fibers such as alpaca, angora, bison down, camel hair, cashmere, catgut, chiengora, guanaco, llama, mohair, pashmina, qiviut, rabbit, silk, sinew, spider silk, wool, vicuna, and yak; vegetable fibers such as aback bamboo, coir, cotton, flax, hemp, jute, kapok, kenaf, pina, raffia palm, ramie, sisal, and wood; mineral fibers such as asbestos, basalt, mineral wool, and glass wool; and cellulose fibers such as acetate, art silk, bamboo, lyocell (tencel), modal, and rayon; or any other natural fiber. Synthetic fibers can include acrylic, aramid (twaron, kevlar, technora, and nomex), carbon (tenax), derclon, microfiber, modacrylic, nylon, olefin, polyester, polyethylene (dyneema, spectra), spandex, vinalon, zylon, or any other synthetic fiber. One of skill in the art will appreciate that fibers can include any natural or synthetic fibers, or any combination thereof, without restriction and without limitation unless otherwise indicated in the claims.

In at least one implementation, the fibers can be used to form a grid. In particular, the first set of fibers can be oriented in a “horizontal” direction; that is, the first set of fibers can be oriented parallel to one another. One of skill in the art will appreciate that horizontal orientation refers to an arbitrary orientation and is not used to limit or restrict the scope of the claims unless otherwise indicated in the claims. Further, the first set of fibers can be spaced equidistant from one another or in a repeating pattern. For example, a first fiber in the first set of fibers might be relatively close to a second fiber in the first set of fibers, which is, in turn, relatively farther from a third fiber in the first set of fibers, with the pattern repeating throughout the fabric. One of skill in the art will appreciate that the spacing of the first set of fibers can be any distance from one another without restriction and without limitation unless otherwise indicated in the claims.

The second set of fibers can be oriented in a “vertical” direction; that is, the second set of fibers can be oriented parallel to one another. One of skill in the art will appreciate that vertical orientation refers to an arbitrary orientation perpendicular to the first set of fibers and is not used to limit or restrict the scope of the claims unless otherwise indicated in the claims. Further, the second set of fibers can be spaced equidistant from one another or in a repeating pattern. For example, a first fiber in the second set of fibers might be relatively close to a second fiber in the second set of fibers, which is, in turn, relatively farther from a third fiber in the second set of fibers, with the pattern repeating throughout the fabric. One of skill in the art will appreciate that the spacing of the second set of fibers can be any distance from one another without restriction and without limitation unless otherwise indicated in the claims.

In at least one implementation, the fibers can be woven together. In particular, weaving is the textile art in which a first set of fibers and a second set of fibers, called the warp and the filling or weft (older woof), respectively, are interlaced with each other to form a fabric or cloth. In particular, the first set of fibers can be held in place while the second set of fibers is woven through them or vice versa. The manner in which the first set of fibers and the second set of fibers interlace with each other is known as the weave. In particular, the weave can include plain weave, satin weave, and twill or any other type of weave.

In at least one implementation, plain weave can include the first set of fibers and second set of fibers aligned so they form a simple criss-cross pattern. Each fiber in the second set of fibers crosses the first set of fibers by going over one, then under the next, and so on. The next fiber in the second set of fibers goes under the first set of fibers that its neighbor went over, and vice versa. The satin weave is characterized by four or more fibers in the second set of fibers floating over a fiber in the first set of fibers or vice versa, four or more fiber in the first set of fibers floating over a single fiber in the second set of fibers. Twill is a type of fabric woven with a pattern of diagonal parallel ribs. It is made by passing the second set of fibers over one or more first set of fibers and then under two or more first set of fibers and so on, with a “step” or offset between rows to create the characteristic diagonal pattern.

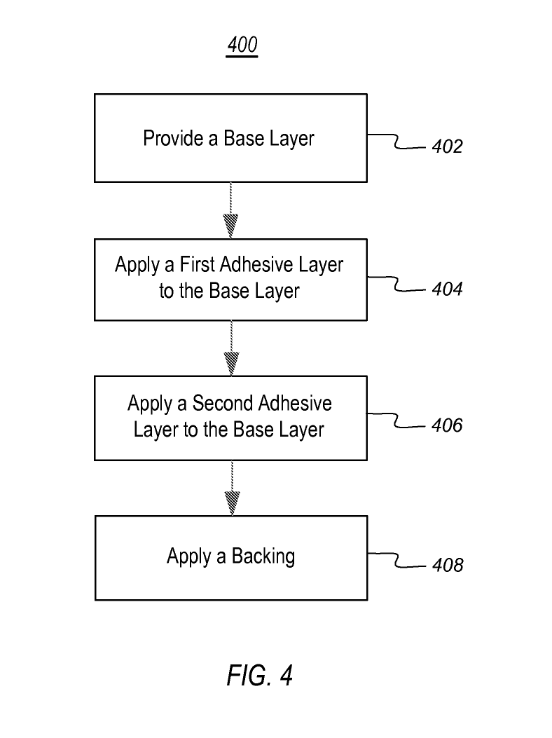

FIG. 4 is a flow chart illustrating a method 400 of manufacturing a system for customizing a cloth. In at least one implementation, the system can include the system 100 of FIGS. 1-3. Therefore, the method 400 will be described, exemplarily, with reference to the system 100 of FIGS. 1-3. Nevertheless, one of skill in the art can appreciate that the method 400 can be used to produce a system other than the system 100 of FIGS. 1-3.

FIG. 4 shows that the method 400 includes providing 402 a base layer. In at least one implementation, the base layer can include any desired material. For example, the base layer can include paper, plastic film, cloth, metal foil or any other desired material. The base layer can be any desired size and shape in order to accommodate the external object. For example, the user may be able to cut or otherwise reshape the base layer. The base layer can include coloring or decorations or can be transparent or semi-transparent.

FIG. 4 also shows that the method 400 can include applying 404 a first adhesive layer to the base layer. In at least one implementation, the first adhesive layer is configured to attach the system to a cloth. I.e., the first adhesive layer can attach the base layer, and any external objects attached thereto, to the cloth. The first adhesive layer can include a pressure sensitive adhesive. Pressure sensitive adhesive is adhesive which forms a bond when pressure is applied to marry the adhesive with the adherend. I.e., no solvent, water, or heat is needed to activate the adhesive

FIG. 4 further shows that the method 400 can include applying 406 a second adhesive layer to the base layer. In at least one implementation, the second adhesive layer is configured to attach the base layer to an external object. In particular, the second adhesive layer can secure the external object to the base layer while the first adhesive layer is secured to the cloth, with the end result being that the external object is secured to the cloth. The second adhesive layer can include the same adhesive or a different adhesive, as desired.

FIG. 4 additionally shows that the method 400 can include applying a backing. In at least one implementation, the backing can protect the adhesive until the desired time of use. I.e., the backing can include a material which attaches to either the first adhesive layer or the second adhesive layer, or both, but does not remove the adhesive layer. The backing can include any desired material. For example, the backing can include a waxed paper.

One of skill in the art will appreciate that the method 400 can include multiple sections of base layer, surrounded by the first adhesive layer and the second adhesive layer separated by a backing. I.e., the backing can protect a first adhesive layer of a first base layer on one side and a second adhesive layer attached to a second base layer on the opposite side. Multiple sections can allow a user to customize multiple cloths with the same art (at different times) or customize the same cloth with the same art multiple times (e.g. after each wash of the cloth).

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

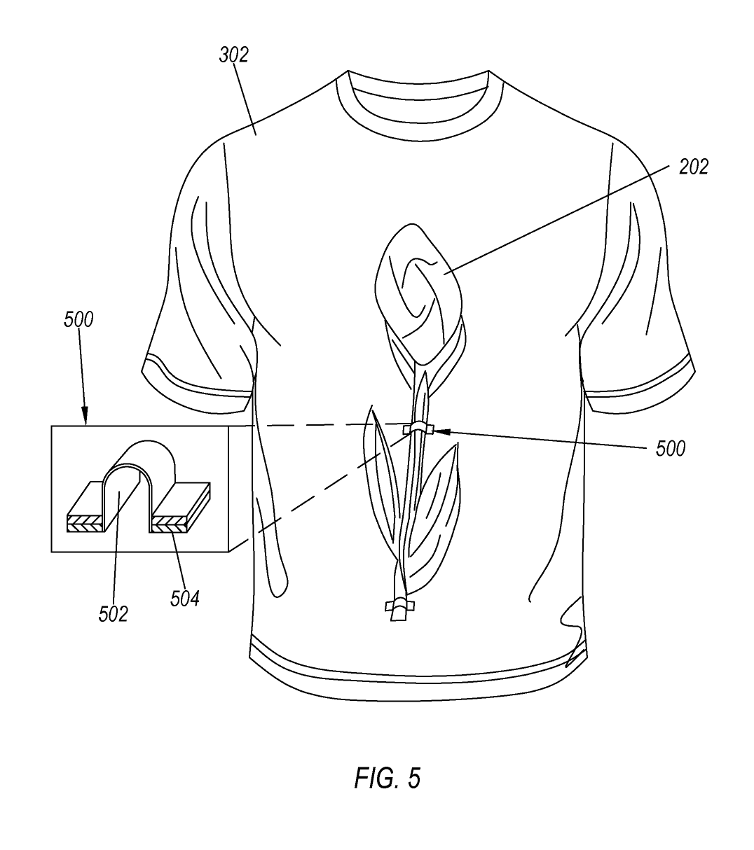

FIG. 5 illustrates an example of a clip 500 for attaching an external object 202 to a cloth 302. In at least one implementation, the clip 500 can be used when the wearer prefers the external object 202 to be visible without an intervening layer. I.e., the clip 500 can ensure that there is not an external cover over the external object 202, making it more visible.

FIG. 5 shows that the clip can include a body 502. In at least one implementation, the body 502 can support the external object 202. I.e., the body 502 can provide sufficient force to support at least part of the weight of the external object 202. Additionally or alternatively, the body 502 can stabilize the position of the external object 202 such that the external object 202 does not move relative to the cloth 302.

FIG. 5 also shows that the clip 500 can include an attachment 504. In at least one implementation, the attachment 504 can allow a user to attach the clip 500 to an external device. In particular, the attachment 504 can create a releasable attachment, allowing the clip 500 to be attached and detached as desired. For example, the attachment 504 can include an adhesive attachment as described above. Additionally or alternatively the attachment 504 can include a hook and loop fastener, a magnetic attachment or any other desired attachment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for attaching an external object to a cloth, the system comprising:
a base layer;
a first adhesive layer, wherein the first adhesive layer is applied to a first side of the base layer; and
a second adhesive layer, wherein the second adhesive layer is applied to a second side of the base layer, wherein the second side of the base layer is opposite the first side.

2. The system of claim 1 further comprising a backing, wherein the backing is configured to protect the first adhesive layer.

3. The system of claim 2 further comprising a second backing, wherein the second backing is configured to protect the second adhesive layer.

4. The system of claim 1 further comprising:
a second base layer;
a third adhesive layer, wherein the third adhesive layer is applied to a first side of the second base layer; and
a fourth adhesive layer, wherein the fourth adhesive layer is applied to a second side of the second base layer, wherein the second side of the second base layer is opposite the first side if the second base layer.

5. The system of claim 4 further comprising a backing, wherein the backing:
separates the second adhesive layer from the third adhesive layer; and
is configured to releasably attach the second adhesive layer to the third adhesive layer.

6. The system of claim 1 further comprising a cloth attached to the first adhesive layer.

7. The system of claim 6, wherein the cloth includes an article of clothing.

8. The system of claim 7, wherein the cloth includes a fabric.

9. The system of claim 1 further comprising an external object attached to the second adhesive layer.

10. The system of claim 9, wherein the external object includes a picture.

11. The system of claim 1, wherein the external object includes a decoration.

12. A system for attaching an external object to a cloth, the system comprising:
a base layer;
a first adhesive layer, wherein the first adhesive layer is applied to a first side of the base layer;
a second adhesive layer, wherein the second adhesive layer is applied to a second side of the base layer, wherein the second side of the base layer is opposite the first side;
a second base layer;
a third adhesive layer, wherein the third adhesive layer is applied to a first side of the second base layer;
a fourth adhesive layer, wherein the fourth adhesive layer is applied to a second side of the second base layer, wherein the second side of the second base layer is opposite the first side of the second base layer; and
a backing, wherein the backing;
separates the second adhesive layer from the third adhesive layer; and
releasably attaches the second adhesive layer to the third adhesive layer.

13. The system of claim 12, wherein the first adhesive layer includes the same adhesive as the second adhesive layer.

14. The system of claim 12, wherein the first adhesive layer includes a pressure sensitive adhesive.

15. The system of claim 12, wherein the base layer includes at least one of:
paper;
plastic film;
cloth; or
metal foil.

16. A method for manufacturing a system for attaching an external object to a cloth, the method comprising:
providing a base layer;
applying a first adhesive layer, wherein the first adhesive layer is applied to a first side of the base layer; and
applying a second adhesive layer, wherein the second adhesive layer is applied to a second side of the base layer, wherein the second side of the base layer is opposite the first side.

17. The method of claim 16 further comprising:
providing a second base layer;
applying a third adhesive layer, wherein the third adhesive layer is applied to a first side of the second base layer; and
applying a fourth adhesive layer, wherein the fourth adhesive layer is applied to a second side of the second base layer, wherein the second side of the second base layer is opposite the first side if the second base layer.

18. The method of claim 17 further comprising:
providing a backing, wherein the backing:
separates the second adhesive layer from the third adhesive layer; and
releasably attaches the second adhesive layer to the third adhesive layer.

19. The method of claim 18, wherein the backing includes a waxed paper.
